(19) United States
(12) Patent Application Publication
(10) Pub. No.: US 2024/0116393 A1
(43) Pub. Date: Apr. 11, 2024

(54) BATTERY MANAGEMENT SYSTEM, BATTERY MANAGEMENT METHOD, AND TERMINAL DEVICE

(71) Applicant: Panasonic Intellectual Property Management Co., Ltd., Osaka (JP)

(72) Inventors: Ryota SAITO, Kanagawa (JP); Masashi TAKEMURA, Kanagawa (JP); Manano TAGUCHI, Kanagawa (JP)

(73) Assignee: Panasonic Intellectual Property Management Co., Ltd., Osaka (JP)

(21) Appl. No.: 18/275,966

(22) PCT Filed: Feb. 1, 2022
(86) PCT No.: PCT/JP2022/003845

§ 371 Date: Aug. 4, 2023

(30) Foreign Application Priority Data
Feb. 12, 2021 (JP) 2021-020683

(51) Int. Cl. B60L 53/80; B60L 53/30; B60L 53/65; B60L 53/66; B60L 53/67; B60L 53/68; G06Q 10/02; G06Q 30/0645

(52) U.S. Cl. CPC B60L 53/80; B60L 53/305; B60L 53/65; B60L 53/665; B60L 53/67; B60L 53/68; G06Q 10/02; G06Q 30/0645; B60L 2200/12; B60L 2250/16

(57) ABSTRACT

A server device acquires profile information (setting information) on user's needs regarding battery replacement from a user terminal, and analyzes historical information on battery replacement at each station to generate an unavailability index representing a degree of unavailability of battery lease. When a specific event occurs (i.e., information on a suitable battery station or an alert of battery replacement necessity is provided), a user terminal displays a notification screen (station screen or alert screen) for notification of the event, generated by the server device based on profile information and an unavailability index.

### TECHNICAL FIELD

The present disclosure relates to a system for providing a user with battery replacement services in which users of electric vehicles and other vehicles can replace battery devices at battery stations. In particular, the present disclosure relates to a battery management system and a battery management method for managing battery stations and battery devices, and a terminal device carried by a user, used in the battery replacement services.

### BACKGROUND ART

In recent years, electric vehicles such as electric motorcycles have been drawing attention from the viewpoint of eliminating air pollution and fuel cost problems caused by exhaust gas. The distance an electric vehicle can travel on one charge has been increasing due to the improved performance of battery devices. However, electric vehicles inconveniently require charging every certain distance, which prevents the electric vehicles from continuous travel for a long time.

Known technologies that can be a solution to such a problem include a system for providing a user with battery replacement services in which a battery device is detachably installed in an electric vehicle and the battery device can be replaced with a new one at a battery station, thereby enabling continuous travel for a long time (Patent Documents 1 and 2).

### PRIOR ART DOCUMENT(S)

### Patent Document(s)

Patent Document 1: JP6564502B
Patent Document 2: JP6766343B

### SUMMARY OF THE INVENTION

### Task to be Accomplished by the Invention

In the prior-art technology disclosed in Patent Document D1, a system estimates an area in which a user can perform battery replacement at a battery station based on real time information including a travel direction of an electric vehicle and a battery remaining amount of the battery of the electric vehicle, and controls the charging operations at battery stations in the area. In addition, the system provides a user with information that leads the user to a nearby battery station.

In the prior-art technology disclosed in Patent Document D2, a system notifies a user of whether or not a battery station stores any charged battery device that can be leased to the user for battery replacement. When there is not any charged battery that can be leased to the user, the system acquires a required wait time to complete preparation of a charged battery device that can be leased to the user. The system calculates the required wait time based on past statistical information. Moreover, the system determines a battery station that is suitable to and to be notified to the user, on the basis of the travel time to the battery station and the required wait time at the battery station.

However, systems of the prior art are configured to determine a battery station as being suitable to a user without consideration of the user's needs, and thus the battery station determined by the systems can be not sufficiently suitable to a user in view of the user's needs. For example, in some cases, a user wants to be led to a battery station where the user can replace batteries in such a way that is preferable or desirable to the user. In other cases, when a user terminal can provide an alert to a user of the needs for battery replacement, the user wants to control the user terminal such that an alert is provided in a preferable or desirable manner to the user. However, systems of the prior art do not satisfy such users' needs.

The present disclosure has been made in view of such problems of the prior art, and a primary object of the present disclosure is to provide a battery management system, a battery management method, and a terminal device which can provide a user with battery replacement services including providing information that leads the user to a suitable battery station and providing an alert of the need for battery replacement in such a way that is preferable or desirable to the user, so that the user can use the services more comfortably.

### Means to Accomplish the Task

An aspect of the present disclosure provides a battery management system comprising: a plurality of battery replacement devices placed at a battery station configured to accommodate a battery device returned by a user to charge the returned battery device, and lease a charged battery device to the user in exchange for the returned battery device; a server device connected to the plurality of battery replacement devices via a network and configured to manage battery replacement statuses of the battery replacement devices; and a terminal device carried by the user and connected to the server device via the network, wherein the server device is configured to: for each battery station, analyze historical information on past battery replacement statuses to generate an unavailability index representing a degree of unavailability of battery lease, and when a specific event associated with battery replacement occurs, generate a notification screen for notification of the specific event based on setting information on the user's needs regarding battery replacement and the unavailability index, and cause the terminal device to display the notification screen.

Another aspect of the present disclosure provides a battery management method for managing battery stations where a user can replace battery devices and managing the battery devices, wherein the method is performed by a server device, the method comprising: for each battery station, analyzing historical information on past battery replacement statuses to generate an unavailability index representing a degree of unavailability of battery lease, and when a specific event associated with battery replacement occurs, generating a notification screen for notification of the specific event based on setting information on the user's needs regarding battery replacement and the unavailability index, and causing a terminal device to display the notification screen.

Yet another aspect of the present disclosure provides a terminal device carried by a user and connected to a server device via a network, configured to: display a setting screen that allows the user to enter information on the user's needs regarding battery replacement; in response to the user's operation on the setting screen, provide setting information on the user's needs regarding battery replacement to the server device; and when a specific event associated with battery replacement occurs in the server device, display a notification screen for notification of the specific event, wherein the server device generates an unavailability index representing a degree of unavailability of battery lease for each battery station by analyzing historical information on past battery replacement statuses, and generates the notification screen based on the setting information on the user's needs regarding battery replacement and the unavailability index.

### Effect of the Invention

According to the present disclosure, a user is provided with battery replacement services including providing information that leads the user to a suitable battery station and providing an alert of the need for battery replacement in such a way that is preferable or desirable to the user, and thus the user can use the services more comfortably. Moreover, a notification screen for notification of a specific event is generated and displayed in a more appropriate manner since the notification screen is generated by using an unavailability index representing a degree of unavailability of battery lease at each battery station.

### BRIEF DESCRIPTION OF THE DRAWINGS

FIG. 1 is a diagram showing an overall configuration of a battery sharing system according to one embodiment of the present disclosure;

FIG. 2 is a block diagram showing schematic configurations of a battery replacement machine 3, a management server 4, and a user terminal 5;

FIG. 3 is an explanatory diagram showing an outline of operations performed by the management server 4;

FIG. 4 is an explanatory diagram showing profile information for each user;

FIG. 5 is an explanatory diagram showing a usage status monitor screen displayed on a management device 6;

FIG. 6 is an explanatory diagram showing a login screen and a start screen displayed on the user terminal 5;

FIG. 7 is an explanatory diagram showing a profile setting screen and a profile registration completion screen displayed on the user terminal 5;

FIG. 8 is an explanatory diagram showing a detailed search screen displayed on the user terminal 5;

FIG. 9 is an explanatory diagram showing station indication screens displayed on the user terminal 5;

FIG. 10 is an explanatory diagram showing station indication screens displayed on the user terminal 5;

FIG. 11 is an explanatory diagram showing a reservation screen and a reservation completion screen displayed on the user terminal 5;

FIG. 12 is an explanatory diagram showing an alert screen displayed on the user terminal 5;

FIG. 13 is a sequence diagram showing procedures of operations performed by the user terminal 5 and the management server 4 when a user logins and sets a profile, respectively;

FIG. 14 is a sequence diagram showing procedures of operations performed by the user terminal 5 and the management server 4 when a user selects an automatic search mode and selects a detailed search mode, respectively; and

FIG. 15 is a sequence diagram showing procedures of operations performed by the user terminal 5 and the management server 4 when a user makes a reservation.

### DESCRIPTION OF THE PREFERRED EMBODIMENT(S)

A first aspect of the present disclosure made to achieve the above-described object is a battery management system comprising: a plurality of battery replacement devices placed at a battery station configured to accommodate a battery device returned by a user to charge the returned battery device, and lease a charged battery device to the user in exchange for the returned battery device; a server device connected to the plurality of battery replacement devices via a network and configured to manage battery replacement statuses of the battery replacement devices; and a terminal device carried by the user and connected to the server device via the network, wherein the server device is configured to: for each battery station, analyze historical information on past battery replacement statuses to generate an unavailability index representing a degree of unavailability of battery lease, and when a specific event associated with battery replacement occurs, generate a notification screen for notification of the specific event based on setting information on the user's needs regarding battery replacement and the unavailability index, and cause the terminal device to display the notification screen.

In this configuration, a user is provided with battery replacement services including providing information that leads the user to a suitable battery station and providing an alert of the need for battery replacement in such a way that is preferable or desirable to the user, and thus the user can use the services more comfortably. Moreover, a notification screen for notification of a specific event is generated and displayed in a more appropriate manner since the notification screen is generated by using an unavailability index representing a degree of unavailability of battery lease at each battery station.

A second aspect of the present disclosure is the battery management system of the first aspect, wherein the server device acquires an amount of time during which battery lease is unavailable within a unit of time, as the unavailability index for each battery station.

In this configuration, an administrator can easily ascertain a degree of unavailability of battery lease at each battery station. An amount of time during which battery lease is unavailable within a unit of time can be used as a wait time required for a user to wait at a battery station before the completion of preparation of a charged battery that can be leased to the user.

A third aspect of the present disclosure is the battery management system of the first aspect, wherein when the specific event occurs in which the server device needs to provide a user with information that leads the user to a battery station, the server device determines a battery station at which battery replacement can be made in such a way that meets the user's needs, and generates the notification screen in which positions of the determined battery stations are overlaid on a map, and causes the terminal device to display the notification screen.

This configuration can notify a user of a battery station at which battery replacement can be made in such a way that meets the user's needs, in an easily understood manner.

A fourth aspect of the present disclosure is the battery management system of the third aspect, wherein the server device acquires information about a reservation for battery replacement, in response to the user's operation on the notification screen displayed on the terminal device.

In this configuration, a user's reservation for battery replacement can be accepted.

A fifth aspect of the present disclosure is the battery management system of the first aspect, wherein the server device acquires and stores the setting information in response to the user's operation on the terminal device, the setting information relating to at least one of information records of a replacement frequency, a wait time, alert use settings, and display settings of the notification screen.

This configuration makes it possible to acquire setting information about the user's need relating to at least one of information records of a replacement frequency, a wait time, alert use settings, and display settings of the notification screen.

A sixth aspect of the present disclosure is a battery management method for managing battery stations where a user can replace battery devices and managing the battery devices, wherein the method is performed by a server device, the method comprising: for each battery station, analyzing historical information on past battery replacement statuses to generate an unavailability index representing a degree of unavailability of battery lease, and when a specific event associated with battery replacement occurs, generating a notification screen for notification of the specific event based on setting information on the user's needs regarding battery replacement and the unavailability index, and causing a terminal device to display the notification screen.

This configuration can achieve the same effect as the first aspect; that is, a user is provided with battery replacement services including providing information that leads the user to a suitable battery station and providing an alert of the need for battery replacement in such a way that is preferable or desirable to the user, and thus the user can use the services more comfortably. Moreover, a notification screen for notification of a specific event is generated and displayed in a more appropriate manner since the notification screen is generated by using an unavailability index representing a degree of unavailability of battery lease at each battery station.

A seventh aspect of the present disclosure is a terminal device carried by a user and connected to a server device via a network, configured to: display a setting screen that allows the user to enter information on the user's needs regarding battery replacement; in response to the user's operation on the setting screen, provide setting information on the user's needs regarding battery replacement to the server device; and when a specific event associated with battery replacement occurs in the server device, display a notification screen for notification of the specific event, wherein the server device generates an unavailability index representing a degree of unavailability of battery lease for each battery station by analyzing historical information on past battery replacement statuses, and generates the notification screen based on the setting information on the user's needs regarding battery replacement and the unavailability index.

This configuration can achieve the same effect as the first aspect; that is, a user is provided with battery replacement services including providing information that leads the user to a suitable battery station and providing an alert of the need for battery replacement in such a way that is preferable or desirable to the user, and thus the user can use the services more comfortably. Moreover, a notification screen for notification of a specific event is generated and displayed in a more appropriate manner since the notification screen is generated by using an unavailability index representing a degree of unavailability of battery lease at each battery station.

Embodiments of the present disclosure will be described below with reference to the drawings.

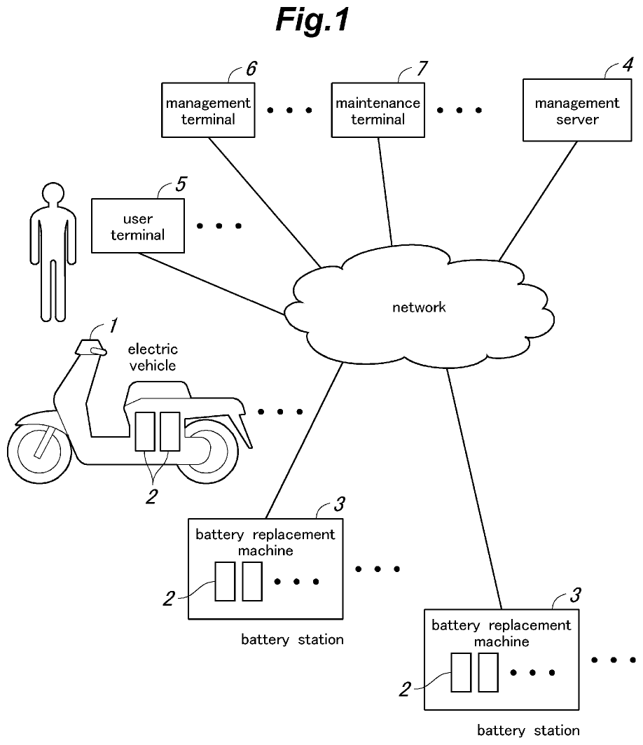

FIG. 1 is a diagram showing an overall configuration of a battery sharing system according to an embodiment of the present disclosure.

The battery sharing system provides services (battery replacement services) in which a plurality of users share battery packs 2 (battery devices) used in electric vehicles 1 such as electric motorcycles. The system includes a battery replacement machine(s) 3 (battery replacement device(s)), a management server 4 (server device), a user terminal(s) 5 (terminal device(s)), a management terminal 6, and a maintenance terminal 7.

The battery replacement machine 3, the management server 4, the user terminal 5, the management terminal 6, and the maintenance terminal 7 are connected to each other via a network such as the Internet. The battery replacement machine 3 and the user terminal 5 are communicatively connected to the network via a wireless communication link such as a mobile communication network or a wireless LAN.

The electric vehicle 1 is equipped with battery pack(s) 2 and travels on the electric power from the battery pack(s) 2. Although, in the example shown in FIG. 1, the electric vehicle 1 is an electric motorcycle, the electric vehicle 1 may be a four-wheeled automobile. In other cases, the electric vehicle 1 may be an electric wheelchair, an electric cart, a passenger cart at a theme park or a golf link, or other mobility devices designed to be mainly used in a place other than a roadway.

The battery replacement machine 3 is used to accommodate a battery pack 2 returned by a user to charge the returned battery pack 2, and lease a charged battery to the user in exchange for the returned battery pack. The battery replacement machine 3 is placed at a battery station in a facility (store) such as a convenience store or a gas station. Generally, two or more battery replacement machines 3 are installed at one battery station.

The management server 4 registers persons who subscribe to a battery replacement service as users (members), and use battery packs 2. The management server 4 manages a battery pack 2 and a link between the battery pack 2 and a user who has leased the battery pack 2. The management server 4 manages the battery replacement status of each battery replacement machine 3. In addition, the management server 4 monitors the status of each battery replacement machine 3 (whether the machine is online or not) and the status of each battery pack 2 accommodated in the battery replacement machine 3 (whether charging of the battery pack has been completed or not), and delivers information on the statuses of the battery replacement machine 3 and the battery pack 2 to the management terminal 6 and the maintenance terminal 7. Moreover, the management server 4 delivers information on the operating status of the battery station and other information to the user terminal 5.

The user terminal 5 is a smartphone, a tablet terminal, or any other mobile device, and adapted to be carried by a user of an electric vehicle 1. The user terminal 5 displays various screens based on information delivered from the management server 4. The screens can notify a user of the position and the operating status of each battery station. The user can operate (e.g., touch) a screen displayed on user terminal 5 in order to make a reservation for battery replacement.

The management terminal 6 is installed in a facility or management center for serving users, and allows an administrator to use it to perform operations for user registration. The management terminal 6 further allows an administrator to view displayed information delivered from the management server 4.

The maintenance terminal 7 is installed in a facility dedicated to maintenance task or in a facility such as a store where a battery station is provided, and allows a person in charge of maintenance to perform necessary operations. The maintenance terminal 7 allows a person in charge of maintenance to view displayed information delivered from the management server 4.

In the present embodiment, a battery pack 2 is used in an electric vehicle. However, a battery-equipped vehicle or device for which the battery pack 2 is used, is not limited to such electric vehicles 1, and may be a portable power supply device or any other suitable vehicle or device.

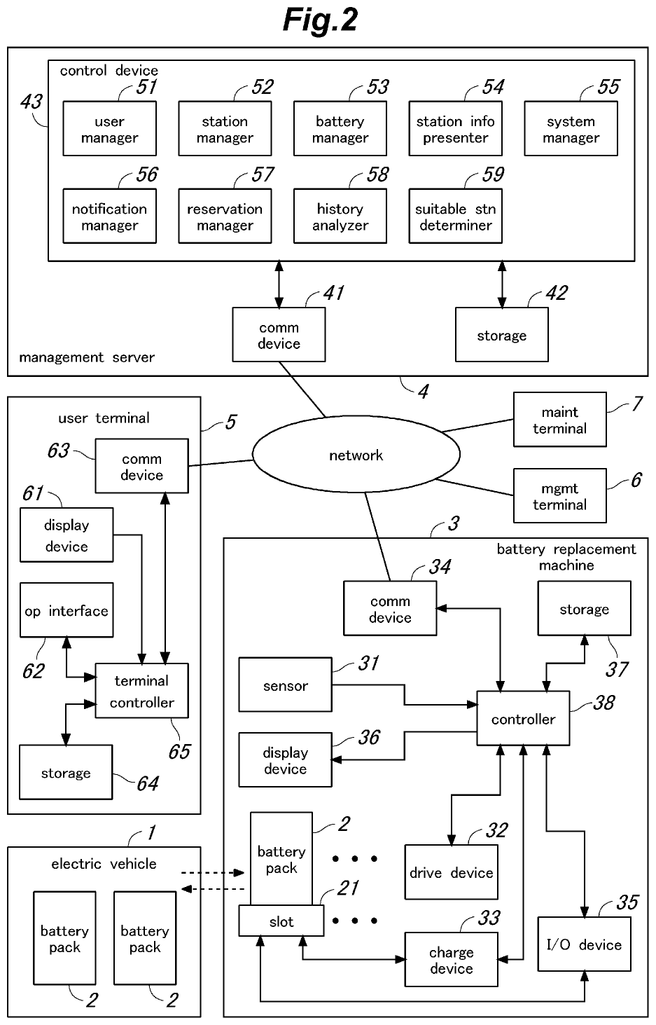

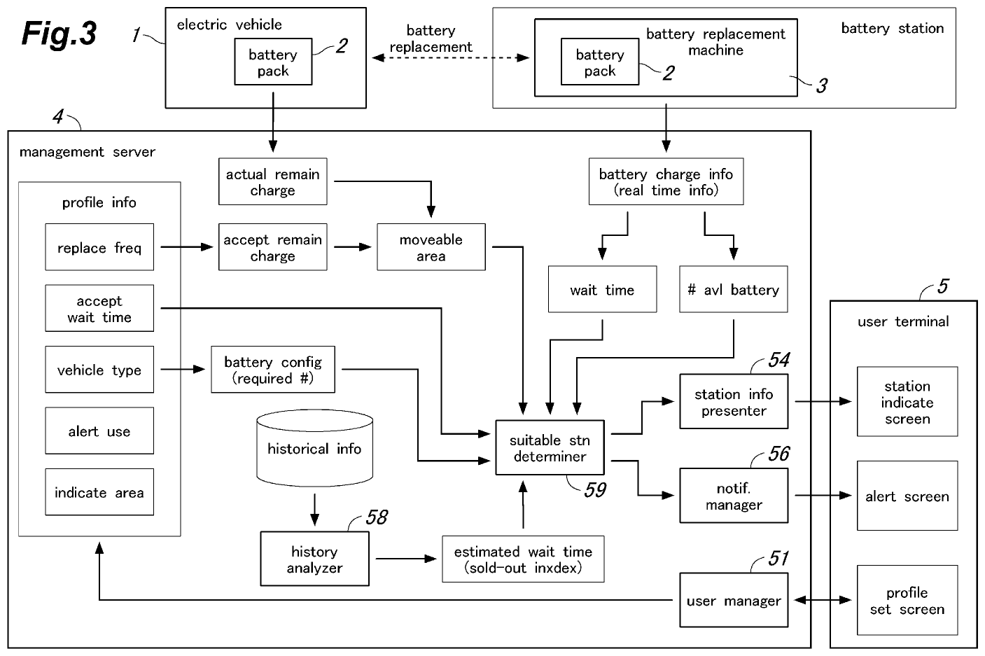

Next, schematic configurations of a battery replacement machine 3, a management server 4, and a user terminal 5 will be described. FIG. 2 is a block diagram showing schematic configurations of the battery replacement machine 3, the management server 4, and the user terminal 5. FIG. 3 is an explanatory diagram showing an outline of operations performed by the management server 4.

The battery replacement machine 3 includes a sensor 31, a drive device 32, a charge device 33, a communication device 34, an input/output device 35, a display device 36, a storage 37, and a controller 38.

The sensor 31 may be e.g., a human sensor, and is configured to detect a person who has come to replace batteries.

In some cases, user authentication may be performed to identify a user who visits for battery replacement. In this case, the identification of a user may be carried out by using facial recognition based on an image captured by a camera. In other cases, a user may be identified through communications with a device carried by the user such as an RFID (Radio frequency identifier) tag, a contactless IC card, and a user terminal 5 capable of using an NFC (Near field Communication) network. In other embodiments, a 2D code attached to each battery pack 2 may be read from an image captured by a camera to thereby detect that a user is returning the battery pack 2.

The drive device 32 drives an opening/closing mechanism of an opening/closing door when a battery pack 2 is returned or leased, according to instructions from the controller 38. Furthermore, the drive device 32 drives a receive/discharge mechanism to receive a battery pack 2 returned from a user or discharge a battery pack 2 to be leased to a user.

The charge device 33 charges each battery pack 2 via a slot 21 (tray).

The communication device 34 communicates with the management server 4 via the network.

The input/output device 35 is used to input and output information to and from a battery pack 2. For example, the battery replacement machine 3 receives the serial number of a battery pack 2, information on alerts, and degradation information from the battery pack 2 through the input/output device 35.

The display device 36 displays an indication screen for indicating information related to the replacement of battery packs 2 to a user.

The storage 37 stores programs that are executable by a processor that implements the controller 38.

The controller 38 is comprised primarily of a processor and controls each element of the battery replacement machine 3. For example, the controller 38 performs controls for the replacement of battery packs 2; that is, the controller 38 controls operation of the drive device 32 so that the battery replacement machine 3 receives a battery pack 2 returned by a user and leases a charged battery pack 2 to the user. Specifically, when the sensor 31 detects a user, the controller 38 starts operations for battery replacement, to thereby open the opening/closing door, thereby prompting the user to return the battery pack 2.

The controller 38 monitors the charge status of battery packs in slots, i.e., the status as to whether each battery pack has been charged or not, and reports information on the charge status of battery packs to the management server 4. This enables the management server 4 to manage the charge status of battery packs 2 in the battery replacement machine 3. The management server 4 generates a list indicating the order of lease of the battery packs 2 according to a rule of order of lease based on the charge status of battery packs 2, and transmits the list to the battery replacement machine 3. As a result, the battery replacement machine 3 can perform efficient lease control when a user's battery pack 2 is replaced with a charged one or a user makes a reservation for battery replacement. In other embodiments, the battery replacement machine 3 may itself control the order of lease of battery packs 2 according to a rule of order of lease based on the charge status of battery packs 2, without using the management server 4.

One or more battery packs 2 can be mounted on an electric vehicle 1. The battery replacement machine 3 can accommodate a plurality of (e.g., eight) battery packs 2. Thus, when an electric vehicle 1 is equipped with a plurality of battery packs 2, a user can replace the plurality of battery packs 2 with charged ones at the same time. In the example shown in FIGS. 1 and 2, two battery packs 2 are mounted on the electric vehicle 1. However, in other embodiments, only one battery pack 2 or three or more battery packs may be mounted on the vehicle.

The management server 4 includes a communication device 41, a storage 42 and a control device 43.

The communication device 41 communicates with the battery replacement machine 3, the user terminal 5, the management terminal 6, and the maintenance terminal 7 via the network.

The storage 42 stores programs that are executable by a processor that implements the control device 43. The storage 42 also stores management information such as user registration information on registered users and link information on a link between each battery pack 2 and a user who has leased the battery pack.

The control device 43 includes a user manager 51, a station manager 52, a battery manager 53, a station information presenter 54, a system manager 55, a notification manager 56, a reservation manager 57, a history analyzer 58, and a suitable station determiner 59. The control device 43 is comprised primarily of a processor, and each element of the control device 43 is implemented by the processor executing a corresponding program stored in the storage 42.

The user manager 51 manages users who use battery packs 2. For example, when receiving a new registration application from a user, the administrator operates the management terminal 6 to acquire user information (user ID, user's name, address, type of an electric vehicle 1 to be used, and other items), allowing the user manager 51 to manage the user information (user registration).

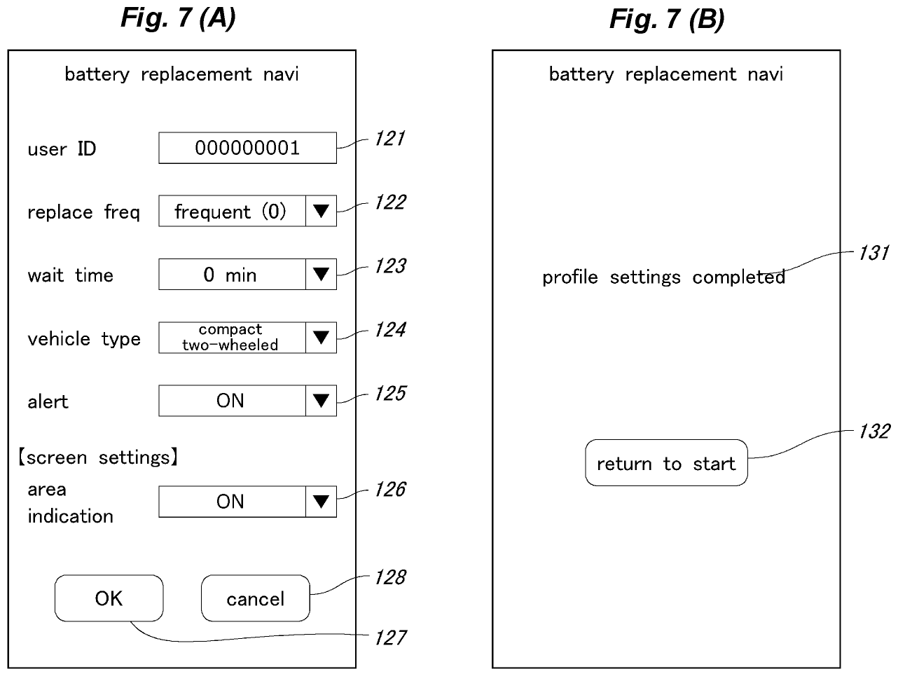

The user manager 51 displays on the user terminal 5 a profile setting screen (see FIG. 7(A)) that enables a user to enter items related to the user's needs regarding battery replacement (such as the user's preference or personal needs). In response to the user's operation on the profile setting screen, the user manager 51 acquires and manages profile information (setting information) on user's needs regarding battery replacement.

The station manager 52 manages each battery station and battery replacement machines 3 placed therein. Specifically, the station manager 52 collects information on the statuses (e.g., operating status) of the battery replacement machines 3 in each battery station from the battery replacement machines 3, and manages the acquired information on the statuses of the battery replacement machines 3. Moreover, the station manager 52 collects, from each battery replacement machine 3, information on the status (e.g., charge status) of each battery pack 2 accommodated in the battery replacement machine 3, and manages the acquired information on the status of each battery pack 2. Information on the status of each battery pack 2 collected and managed by the station manager 52 may include various items such as a degradation level, a period of use, and the number of battery replacements.

The battery manager 53 manages battery packs 2 accommodated in battery replacement machines 3 and battery packs 2 that are currently leased to users.

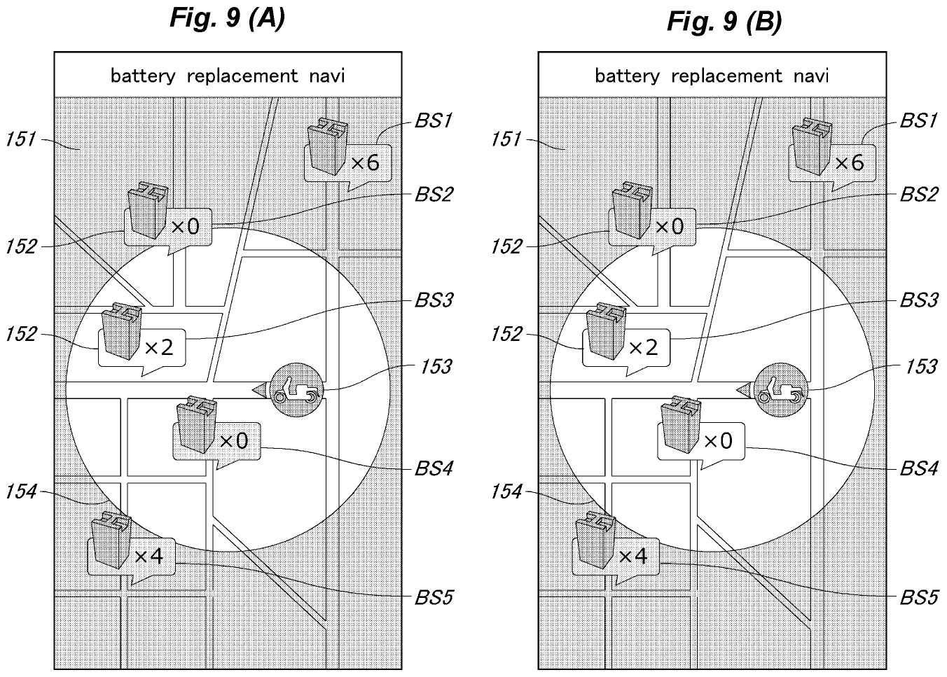

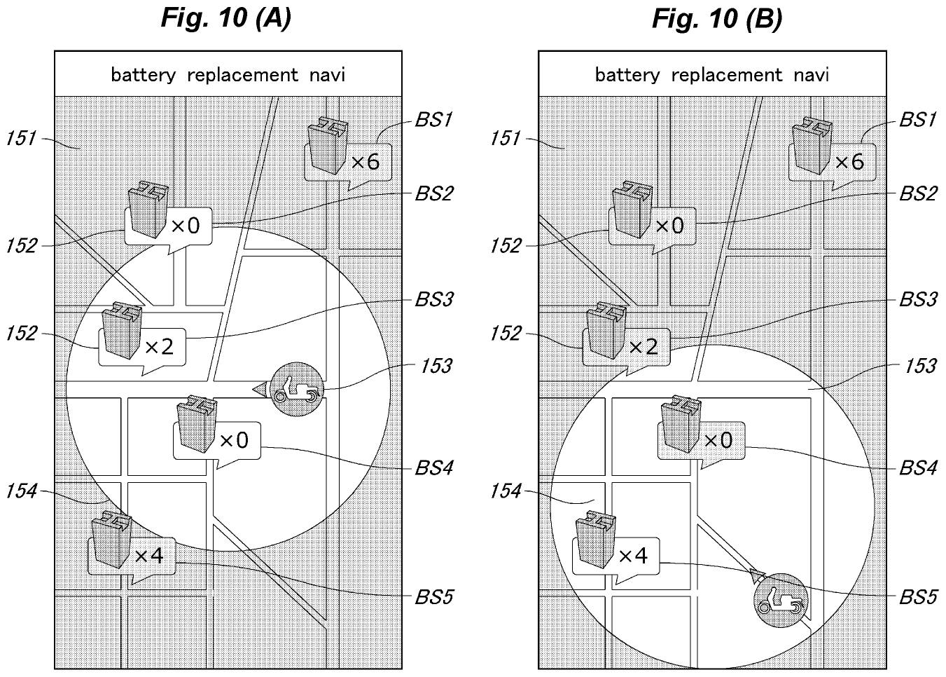

The station information presenter 54 presents information on battery stations to a user. In the present embodiment, the station information presenter 54 generates information related to a station indication screen (see FIGS. 9 and 10) that leads a user to a suitable battery station, and delivers the generated information to the user terminal 5 so that the user terminal 5 can display the station indication screen. The station indication screen notifies a user of information on the position of a battery station and the number of battery packs 2 available for battery replacement at the battery station.

The station information presenter 54 searches the map of a target area from the overall map of the battery replacement service (map search). When a user selects a detailed search mode and designates a certain position, the station information presenter 54 sets a target area using the designated position as a reference position. When a user selects an automatic search mode or when a user selects the detailed search mode and does not designate a certain position, the station information presenter 54 sets a target area using the current position of an electric vehicle 1 as a reference position.

The station information presenter 54 acquires information about a battery station to which a user is to be led; that is, a “suitable battery station” determined by the suitable station determiner 59, as one at which battery replacement can be made in such a way that meets the user's needs and to which the user should be led for the battery replacement (battery station information acquisition).

Specifically, the station information presenter 54 acquires the position data of a suitable battery station. When a user selects the automatic search mode or when a user selects the detailed search mode and does not designate a date and time, the station information presenter 54 uses the current date and time as a reference time, and acquires information about the charge status of battery packs 2 (i.e., information on the number of charged battery packs that can be leased to the user for battery replacement) at a suitable battery station (i.e., a battery station to which the user is to be led).

The system manager 55 monitors the status of the system and presents the status of the system to an administrator and a person in charge of maintenance. For example, the system manager 55 generates information on a management screen indicating the status of the system and delivers the information to the management terminal 6 and the maintenance terminal 7 so that the management terminal 6 and the maintenance terminal 7 can display the respective management screens. As a result, an administrator and a person in charge of maintenance can view the status of the system.

The notification manager 56 manages notification to users. Specifically, the notification manager 56 delivers to the user terminal 5 notification information including information on the establishment or closure of a battery station, information on maintenance work to be carried out at a battery station, and information on the inability to make reservations for battery replacement at a battery station due to network failures or other reasons.

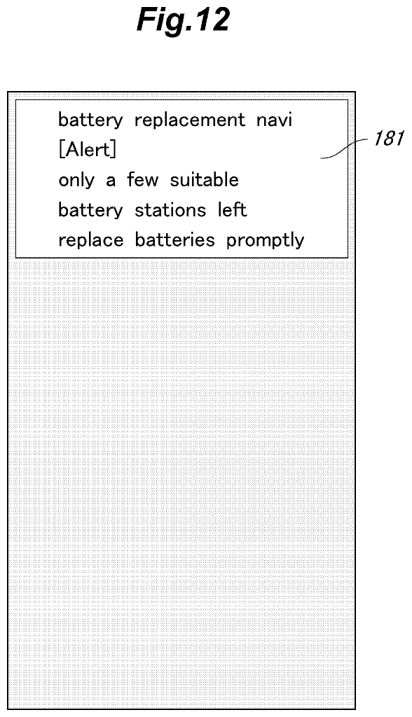

The notification manager 56 determines whether or not a predetermined notification condition is met (notification determination), and when the predetermined notification condition is met, provides an alert of the need for battery replacement (battery replacement necessity notification). Provision of an alert is carried out only when a user designates the necessity of alert. In the present embodiment, an alert screen (see FIG. 12) is displayed on the user terminal 5 as an alert notification.

In the present embodiment, a notification condition (a condition for providing an alert of the need for battery replacement) is met when a user is predicted to lose a suitable battery station within a predetermined time; that is, there will be not any battery station determined by the suitable station determiner 59 as one at which battery replacement can be made in such a way that meets the user's needs and to which the user should be led for the battery replacement. When determining whether the notification condition is met or not, the suitable station determiner 59 determines a suitable station (suitable station determination operation) using the present moment as a reference time, and also performs the suitable station determination operation using a predetermined period of time after the present moment as a reference time.

The reservation manager 57 manages a user's reservation for battery replacement. Specifically, when a user operates on the user terminal 5 to make a reservation, the reservation manager 57 receives the user's reservation for battery replacement. When the user operates on the user terminal 5 to cancel the reservation, the reservation manager 57 cancels the reservation for battery replacement. Furthermore, when a battery replacement is not carried out even after a predetermined period of time has passed after accepting the reservation for battery replacement, the reservation manager 57 also forcibly cancels the reservation for battery replacement.

The history analyzer 58 analyzes historical information about past battery charge and replacement statuses of battery packs 2 at each battery station, and acquires a sold-out index as an analysis result. This sold-out index (herein also referred to as “unavailable index”) quantitatively evaluates the degree of opportunity loss due to failure to provide battery replacement services to users at each battery station; that is, the degree of occurrence of a state in which there is not any charged battery packs 2 that can be leased to users at each battery station (lease-unavailable state).

In the present embodiment, the history analyzer 58 acquires an amount of time during which the lease-unavailable state occurs within a unit of time (e.g., one hour), as a sold-out index (an unavailability index). The amount of time during which battery lease is unavailable within a unit of time corresponds to an average wait time required for a user to wait at a battery station before the completion of preparation of charged battery packs that can be leased to the user (available charged battery packs). Thus, in the present embodiment, an amount of time of occurrence of the lease-unavailable state in each time-of-day period is used as an estimated wait time for each time-of-day period. The history analyzer 58 analyzes historical information over a period of time designated by a user (for example, one week, one month, or one year).

The history analyzer 58 can estimate a user's wait time at a battery station based on real-time information about the current charge status of battery packs at the battery station. Specifically, the history analyzer 58 can acquire the time required for the completion of charging of battery packs at a battery station (charge completion time) as a user's wait time. Thus, the history analyzer 58 may acquire an estimated wait time based on both the wait time estimated from such real-time information (charge completion time) and the wait time estimated from the historical information (sold-out index or unavailability index).

In this case, the history analyzer 58 may compare the wait time estimated from the real-time information with the wait time estimated from the historical information and determines the longer wait time of the two as an estimated wait time. For example, when the wait time estimated from the real-time information is 3 minutes and the wait time estimated from the historical information is 7 minutes, the history analyzer 58 sets the estimated wait time to 7 minutes.

The suitable station determiner 59 determines whether or not a battery station is a suitable battery station; that is, a battery station at which battery replacement can be made in such a way that meets the user's needs and to which the user should be led for the battery replacement, based on the user's profile information or other information records.

Specifically, the suitable station determiner 59 determines whether or not the status of a battery station can meet the requirements for the user's battery configuration; that is, whether or not there are as many available charged battery packs 2 as the number of battery packs 2 required for the electric vehicle 1 of the user (battery configuration determination). When the status of a battery station does not meet the requirements for the user's battery configuration (i.e., the battery station cannot lease the required number of battery packs 2), the suitable station determiner 59 determines that the battery station is not a suitable battery station.

In the present embodiment, the battery replacement services provide one type of battery pack 2, and the battery configuration of an electric vehicle 1 includes the number of batteries mounted therein. However, the battery replacement services may provide two or more types of battery packs 2 (for example, batteries with large and small battery capacities). In this case, the battery configuration includes the types of battery packs 2 in addition to the number of batteries mounted therein.

In the present embodiment, the suitable station determiner 59 determines whether or not a battery station is located within a vehicle movable area; i.e., an area within which an electric vehicle 1 of a user can move (area determination). In this case, the suitable station determiner 59 acquires the movable distance of the electric vehicle 1 based on (i) an acceptable battery remaining amount of battery packs 2 determined from the replacement frequency designated by the user (the lower limit of the battery remaining amount acceptable by the user); (ii) the actual battery remaining amount of the battery packs 2 mounted on the electric vehicle 1 of the user; and (iii) the electric power consumption of the electric vehicle 1 of the user (movable distance per unit capacity of the battery packs 2). The vehicle movable area is a circular area having a radius equal to the acquired movable distance.

In the present embodiment, the suitable station determiner 59 determines whether or not charged battery packs 2 that can be leased to the user (available charged battery packs) can be prepared within the wait time set by the user (acceptable wait time), based on the estimated wait time for each battery station acquired by the history analyzer 58 (wait time determination). Specifically, when the estimated wait time of a battery station is shorter than the user's acceptable wait time, the suitable station determiner 59 determines that the battery station is a suitable battery station. When the estimated wait time of a battery station is longer than the user's acceptable wait time, the suitable station determiner 59 determines that the battery station is not a suitable battery station.

The suitable station determiner 59 determines whether or not the battery station is a suitable battery station, using the present moment or a certain future time point as the reference time. Specifically, when the automatic search mode is selected and the user's acceptable wait time is 0 minute, the present moment is used as the reference time. When the automatic search mode is selected and the user's acceptable wait time is more than 0 minute, or when the detailed search mode is selected and a future time point is used as a reference time for searching, the future time point is used as the reference time for the suitable station determination.

The user terminal 5 includes a display device 61, an operation interface 62, a communication device 63, a storage 64, and a terminal controller 65.

The display device 61 displays various screens, such as a station indication screen for indicating battery stations, and a reservation screen used for making reservations for battery replacement. The operation interface 62 serves an interface for various screen operations on the screen displayed on the display device 61. In some cases, the display device may be a touch panel display, the touch panel display including a display panel as the display device 61 and a touch panel as the operation interface 62 in an integrated manner.

The communication device 63 communicates with the management server 4 via a network.

The storage 64 stores programs that are executable by a processor that implements the terminal controller 65.

The terminal controller 65 is comprised primarily of a processor and performs various processing operations related to battery station indication and battery replacement reservation. Specifically, in response to a user's operations on the operation interface 62, the terminal controller 65 controls the display device 61 so as to display the station indication screen for indicating the position of a battery station(s), the reservation screen used to make a reservation for battery replacement, and other different screens, based on information delivered from the management server 4.

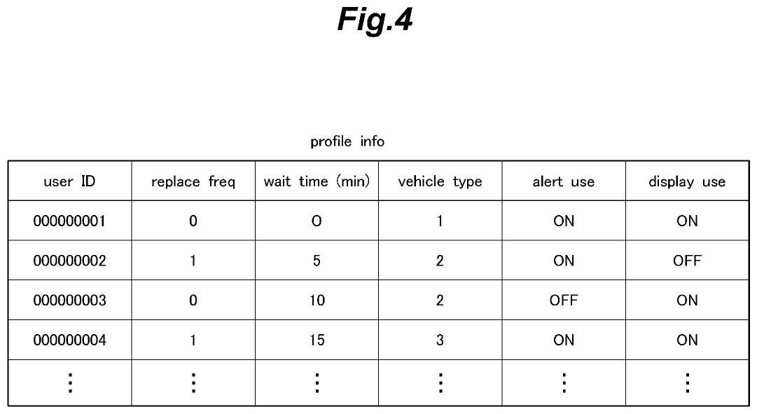

Next, profile information managed by the user manager 51 of the management server 4 will be described. FIG. 4 is an explanatory diagram showing profile information for each user.

The user manager 51 of the management server 4 manages profile information for each user. The profile information is related to each user's needs (preferences or personal needs) for battery replacement. The profile information is acquired from the user terminal 5 according to a user's operation on the user terminal 5 and stored in the storage 42 of the management server 4.

The profile information includes, for each user, a user ID as well as setting information including a replacement frequency, a wait time, a vehicle type, alert use settings, and display use settings of the notification screen. When a user selects one of the service grades and a corresponding fee for battery replacement services, the profile information may further include items of period of use of batteries (a battery degradation level), favorite region, favorite battery station, type of membership, and other data.

The item of user ID includes a user ID (user number) that identifies a registered user. By using the user ID, the user manager 51 can acquire membership information and billing type (such as payment of fees for each replacement or payment of fixed fees) of each registered user, who is allowed to use the battery replacement services. The user manager 51 can determine, based on the billing type of a user, behavioral characteristics of the user regarding battery replacement, such as the intervals of battery replacement.

The item of “replacement frequency” includes an option selected from “frequent replacement” (set value: 0) and “long travel” (set value: 1) as each registered user's need (preference or personal need) of the battery replacement frequency. The set value 0 for “frequent replacement” is selected when the user wants to replace battery backs 2 well before the battery remaining amount becomes low. The set value 1 for “long travel” is selected when the user wants to replace battery packs at the time when the battery remaining amount is close to zero. In the present embodiment, the user's acceptable battery remaining amount (the lower limit of the battery remaining amount that the user can accept) is determined by the replacement frequency. For example, in the case of “frequent replacement”, the time for battery replacement is when the battery remaining amount of the battery packs 2 reaches 50%, which is the acceptable battery remaining amount. In the case of “long travel”, the time for battery replacement is when the battery remaining amount of the battery packs 2 reaches 30%, which is the acceptable battery remaining amount. In other cases, the replacement frequency for each user may be estimated based on the records of battery remaining amounts of the battery packs 2 returned in the past.

The item of “wait time” includes an acceptable wait time as each registered user's need (preference or personal need) of the wait time. The acceptable wait time is a maximum wait time that a user can tolerate when the user waits at a battery station before the preparation of a required number of available charged battery packs. In the present embodiment, a user is allowed to select from options consisting of, for example, 0 minute, 5 minutes, 10 minutes, and 15 minutes as the acceptable wait time.

The item of “vehicle type” includes registered information on the vehicle type of an electric vehicle 1 used by each user. The vehicle type is selected from options consisting of, for example, a compact vehicle with one battery pack 2 (set value: 1), a medium-sized vehicle with two battery packs 2 (set value: 2), and a large-sized vehicle with four battery packs (set value: 3). From the vehicle type information, the user manager 51 can acquire the number of battery packs 2 mounted on the electric vehicle 1 used by the user; that is, the number of battery packs 2 required by the user when replacing the battery packs. In addition, the user manager 51 can acquire a rough estimation of electricity consumption (travel distance per unit capacity of the battery pack 2) based on the vehicle type.

The item of “alert use settings” includes registered information as to whether or not each user needs provision of an alert of the need for battery replacement (battery replacement necessity notification). In the present embodiment, as an alert of the need for battery replacement, an alert screen (see FIG. 12) is displayed on the user terminal 5 to notify that a user will soon lose suitable battery stations (at which battery replacement can be made in such a way that meets the user's needs).

The item of “display settings” includes registered information as to whether or not a user needs an indication of an area within which the user's electric vehicle 1 can move (vehicle movable area) on the display. In the present embodiment, the station indication screen (see FIGS. 9 and 10) may indicate a vehicle movable area overlaid in an area map 151 (road map) including road conditions in a nearby area.

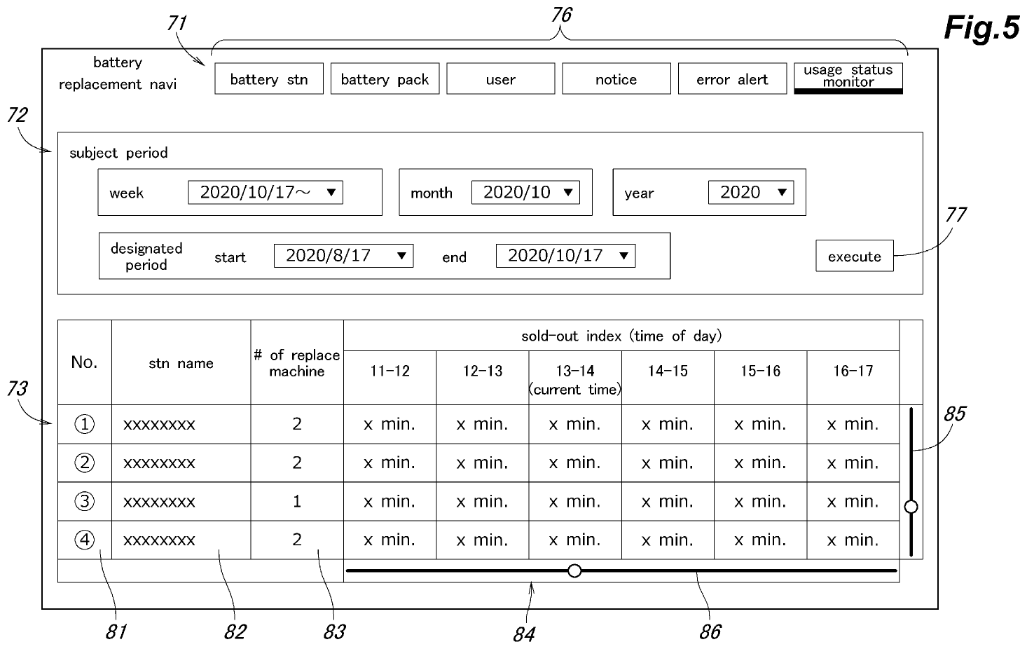

Next, a usage status monitor screen displayed on the management terminal 6 will be described. FIG. 5 is an explanatory diagram showing the usage status monitor screen. In the present embodiment, when an administrator accesses the management server 4 from the management terminal 6 and logs in, the management terminal 6 displays a usage status monitor screen as a management screen.

The usage status monitor screen includes a menu selection section 71, an analysis period setting section 72 and an analysis result display section 73.

The menu selection section 71 includes a plurality of tabs 76 each representing a corresponding menu. In the example shown in FIG. 5, the menu selection section 71 includes a plurality of tabs 76 for battery station, battery pack, user, notice, error/alert, and usage status.

When the usage status tab 76 is selected, the usage status monitor screen is displayed as shown in FIG. 5.

When the battery station tab 76 is selected, a station information list screen (not shown) is displayed. The station information list screen includes a list of information about each battery station. Specifically, the station information list screen indicates, for each battery station, ID number, name, the number of battery replacement machines 3, operation status, network status, the number of charged packs (the number of charged battery packs 2), abnormality in battery replacement machines 3, abnormality in battery packs 2, and other information records.

When the battery pack tab 76 is selected, the screen transitions to a battery pack list screen (not shown). The battery pack list screen includes a list of information about each battery pack. Specifically, the battery pack list screen indicates for each battery pack 2, serial number, information on location and status 2 (including user in use, battery replacement machine 3 in accommodation), and other information records.

When the user tab 76 is selected, the screen transitions to a user list screen (not shown). The user list screen includes a list of information about each registered user. Specifically, the user list screen indicates, for each user, user ID, name, age, sex, ID of the electric vehicle 1 in use, information on the battery packs 2 in use (battery pack IDs), registration date, and other information records.

When the notice tab 76 is selected, the screen transitions to a notice list screen (not shown). The notice list screen includes historical information associated with each notice (notification message) provided in the past. Specifically, the user list screen indicates, for each notice, date and time, notified contents, and other data. The notice list screen can transition to a notice registration screen on which an administrator can operate for registration of a new notice. Specifically, the administrator can enter a title, a display period, and contents of a new notice, and perform the registration operation on the screen.

When the error/alert tab 76 is selected, the screen transitions to an error/alert list screen (not shown). The error/alert list screen includes historical information about errors and alerts associated with the battery replacement machine 3 which were output in the past. Specifically, the error/alert list screen includes output date and time, contents, and other data of each error/alert.

The menu selection section 71 may further include a tab (history search tab) for transition to a screen for searching historical information such as historical data of a user's usage and historical data of the system operation, and a tub (maintenance setting tab) for transition to a screen on which an administrator can configure settings.

The analysis period setting section 72 can be used by an administrator to designate a period of time to be subjected to analysis (subject period). In the example shown in FIG. 5, a subject period can be selected from pull-down menu options consisting of one month, one year, and a designated period. When an administrator designates the subject period and operates an execution button 77, analysis is performed on historical information over the designated subject period and the analysis result is displayed in the analysis result display section 73.

The analysis result display section 73 includes a station number column 81, a name column 82, a column 83 for the number of battery replacement machines, and a sold-out index column 84.

The station number column 81 indicates the ID number of each battery station, and the name column 82 indicates the name of each battery station. The column 83 for the number of battery replacement machines indicates the number of battery replacement machines installed in each battery station.

The sold-out index column 84 indicates, for each battery station, sold-out indexes (unavailability indexes) for respective time-of-day periods. In the present embodiment, the sold-out index column 84 contains an amount of time during which the lease-unavailable state occurs in each time-of-day period, as a sold-out index. This amount of time during which battery lease is unavailable corresponds to an average wait time required for a user to wait at a battery station before the preparation of charged battery packs that can be leased to the user.

The sold-out index column 84 has a vertical scroll bar 85 and a horizontal scroll bar 86. By manipulating the vertical scroll bar 85, a user can scroll up and down the screen to show sold-out indexes for battery stations hidden in the margin in the column 84. By manipulating the horizontal scroll bar 86, a user can scroll to the left and right the screen to show sold-out indexes for time-of-day periods hidden in the margin in the column 84.

In the present embodiment, each time-of-day period is set to one (1) hour period, which means that a sold-out index is determined for each one hour period. However, a time period of each time-of-day period is not limited to one hour period. For example, a sold-out index may be determined d for each time period longer than one hour period.

In the present embodiment, what is used as an index representing a degree of unavailability of battery lease (sold-out index or unavailability index) for each battery station is an amount of time during which battery lease is unavailable in a period of each time-of-day period. However, in some cases, a rate of the amount of time during which battery lease is unavailable to the time period of each time-of-day period may be used as an unavailability index.

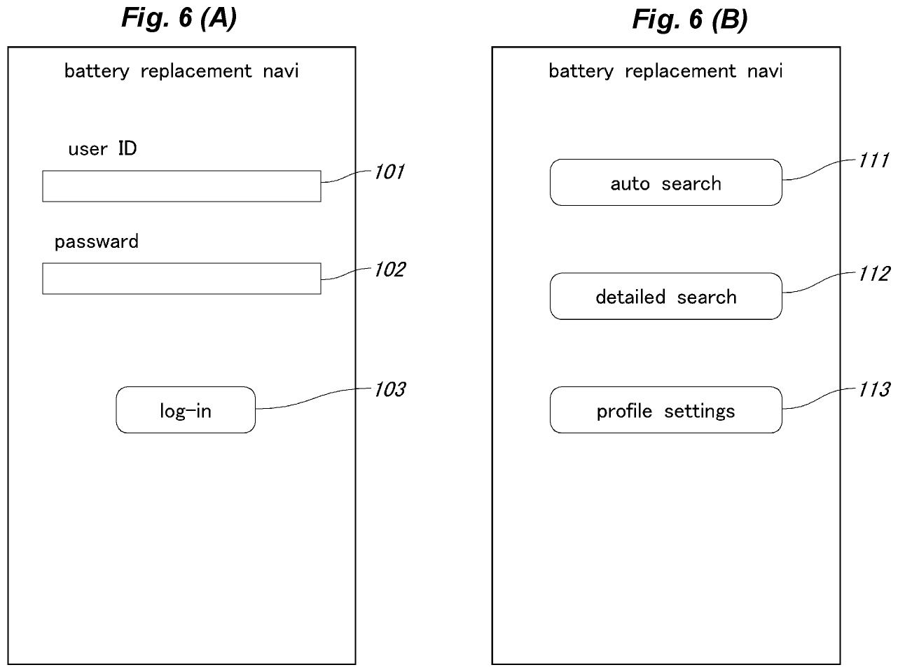

Next, a login screen and a start screen displayed on a user terminal 5 will be described. FIG. 6 is an explanatory diagram showing the login screen and the start screen.

The login screen shown in FIG. 6(A) is displayed on the user terminal 5 when the user terminal 5 accesses the management server 4. The login screen and subsequent screens are displayed by a battery station navigation application (for example, a mobile terminal OS compatible application, web browser) installed on the user terminal 5.

The login screen includes a user ID entry field 101, a password entry field 102 and a login button 103. When a user enters the user's user ID and password and operates the login button 103, the management server 4 verifies the user through user authentication based on the user ID and password.

When user authentication successfully completes, the screen displayed on the user terminal 5 transitions to a start screen (FIG. 6(B)).

The start screen (menu screen) shown in FIG. 6(B) includes buttons 111, 112, and 113 for “automatic search mode”, “detailed search mode”, and “profile settings.”

When a user operates the “automatic search mode” button 111 on the start screen, the management server 4 performs a battery station search based on predetermined search conditions based on each user's profile information that has been preliminary stored therein. Then, the screen transitions to a “station indication screen” (see FIGS. 9 and 10) that indicates to the user a battery station(s) as a search result.

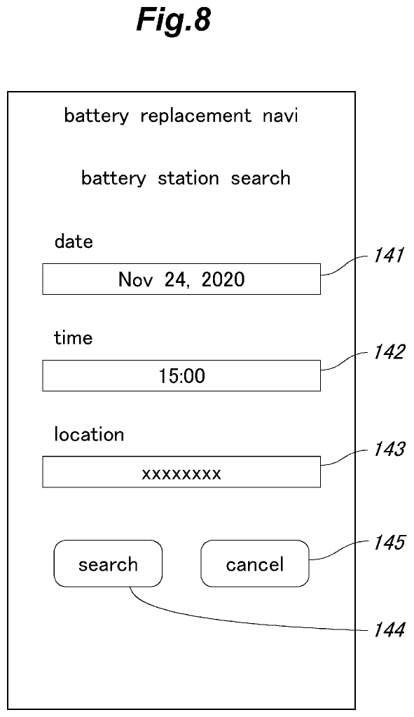

When a user operates the “detailed search mode” button 112, the screen transitions to a detailed search screen (see FIG. 8) that allows the user to enter search conditions to thereby cause the management server 4 to search for battery stations based on the user's search conditions.

When a user operates the “profile settings” button 113, the screen transitions to a profile setting screen (see FIG. 7(A)) that allows the user to set the user's preferences and personal needs as a profile.

Next, a profile setting screen and a profile registration completion screen displayed on the user terminal 5 will be explained. FIG. 7 is an explanatory diagram showing the profile setting screen and the profile registration completion screen.

The profile setting screen shown in FIG. 7(A) is displayed when a user selects “profile settings” on the start screen (see FIG. 6(B)).

The profile setting screen includes a user ID indicator 121, a replacement frequency select menu 122, a wait time select menu 123, a vehicle type select menu 124, an alert select menu 125, an area indication select menu 126, an OK button 127, and a cancel button 128.

The user ID indicator 121 indicates the user ID (user number) of the logged-in user.

The replacement frequency select menu 122 allows a user to select an option regarding battery replacement frequency from pull-down menu options consisting of “frequent replacement” (set value: 0) and “long travel” (set value: 1) according to each user's need (preference or personal need) of the battery replacement frequency. For example, when a user needs to minimize the worry about running out of electricity (a state in which the battery packs 2 run out of charge and the vehicle can no longer travel), the user can select “frequently replacement”. When the user's billing type is “payment of fees for each replacement”, the user can select “long travel”, enabling battery charge to be used to the limit to thereby minimize the cost of battery replacement.

The wait time select menu 123 allows a user to select an option of acceptable wait time from pull-down menu options (e.g., options consisting of 0 minute, 5 minutes, 10 minutes, and 15 minutes) according to the user's need (preference, or personal need).

The vehicle type select menu 124 allows a user to select an option of the vehicle type of an electric vehicle to be used from pull-down menu options. Example of the menu options of vehicle types include a compact vehicle with one battery pack 2 (set value: 1), a medium-sized vehicle with two battery packs 2 (set value: 2), and a large-sized vehicle with four battery packs 2 (set value: 3).

The alert select menu 125 allows a user to select one (ON or OFF) from pull down menu options of whether or not the system provides an alert of the need for battery replacement.

The area indication select menu 126 allows a user to select one (ON or OFF) from pull down menu options of whether or not the system indicates a vehicle movable area (see FIGS. 9 and 10. When the type of membership of a user can be identified based on the user ID or other information, the profile setting screen may be preset with recommended settings (popular settings) when being displayed first, and allow a user to modify the recommended settings according to the user's preferences. The profile setting screen may allow a user to select an acceptable charging rate, so that even battery packs 2 that are not fully charged but are charged to a predetermined level (for example, 80% charged) is available for battery lease.

When a user makes a selection on each item in the profile setting screen and then operates the OK button 127, the management server 4 performs an operation for registration of selection records entered by the user as profile information. In response to the registration, the screen displayed on the user terminal 5 transitions to the profile registration completion screen (see FIG. 7(B)). When a user operates the cancel button 128, the screen returns to the start screen (see FIG. 6(B)).

The profile registration completion screen shown in FIG. 7(B) includes characters 131 indicating that profile registration has been completed, and a button 132 for returning to the start screen.

Next, a detailed search screen displayed on the user terminal 5 will be described. FIG. 8 is an explanatory diagram showing the detailed search screen.

The start screen (see FIG. 6(B)) transitions to the detailed search screen when the “detailed search mode” is selected in the start screen.

The detailed search screen includes a date entry field 141, a time entry field 142, a location entry field 143, a search button 144, and a cancel button 145.

A user can enter a date (year, month, day) as a search condition to the date entry field 141. In some cases, a calendar screen or other feature may be used to allow a user to select a date thereon. A user can enter a time as a search condition to the time entry field 142. The time entry field 142 may indicate the current date and time (date and time) in an initial state. In this case, when the user does not operate to designate a date and time, the current date and time may be used as a search time for a battery station search. A user can enter a location in the location entry field 143 as a search condition. For the location entry, a user may be allowed to select one district within a service area from pull-down menu options, or to designate a location from an overall map of the service area.

When a user enters search conditions (date, time, location) and operates the search button 144, the management server 4 performs a battery station search based on the entered search conditions, and the user terminal 5 displays the station indication screen (see FIGS. 9 and 10) that indicates a battery station(s) as a search result, to the user. When the user operates the cancel button 145, the screen returns to the start screen (see FIG. 6(B)).

Next, station indication screens displayed on the user terminal 5 will be described. FIGS. 9 and 10 are explanatory diagrams showing station indication screens displayed on the user terminal 5.

When a user selects the automatic search mode on the start screen (see FIG. 6(B)), the screen transitions to a station indication screen. In other cases, when a user enters search conditions (date, time, location) on the detailed search screen (see FIG. 8) and operates the search button 144, the screen transitions to a station indication screen.

A station indication screen includes a battery station map in which battery station icons 152 representing battery stations are overlaid on an area map 151 (road map). Each battery station icon 152 indicates the number of charged battery packs 2 that can be leased to the user at the corresponding battery station.

The station indication screen includes an electric vehicle icon 153 representing the current location of the electric vehicle 1 overlaid on the area map 151. The management server 4 acquires the position data from the user terminal 5 and causes the user terminal 5 to indicate the icon 153 of the electric vehicle based on the position data.

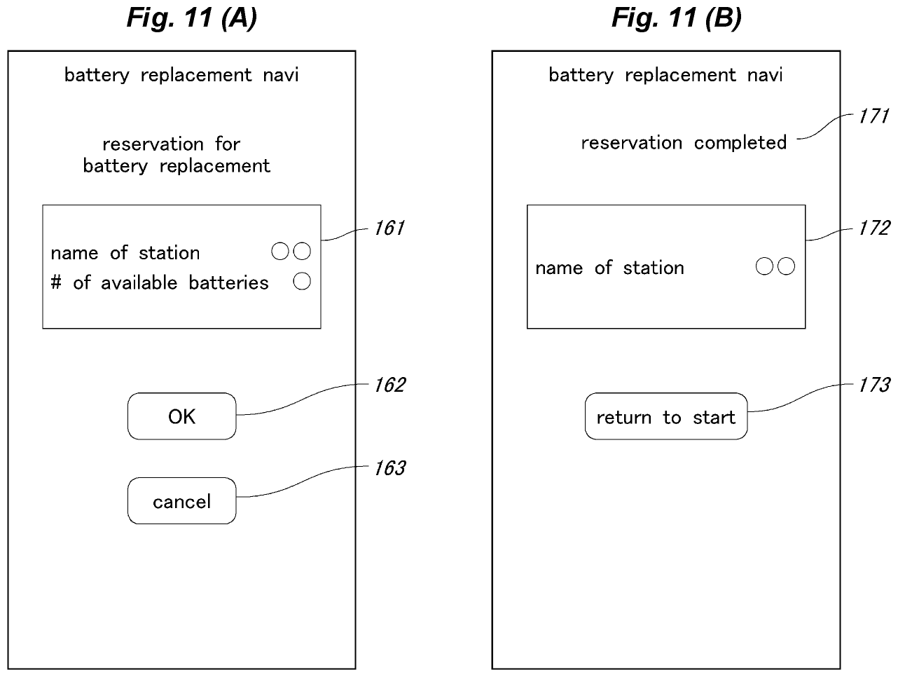

A user can operate the station indication screen to select a battery station icon 152. When the user operates (e.g., taps) a battery station icon 152, the screen indicates detailed information (such as location, contact information) about the corresponding battery station. When the user operates (e.g., long-presses) the battery station icon 152 on the station indication screen, the screen transitions to a reservation screen (see FIG. 11(A)).

The station indication screen indicates a vehicle movable area 154 on an area map 151 (road map). The vehicle movable area 154 is an area in which the electric vehicle 1 of the user can move without battery replacement. In the examples shown in FIGS. 9 and 10, the vehicle movable area is a circular area having a radius equal to the movable distance of the electric vehicle 1 from the current location thereof, where the movable distance of the electric vehicle 1 is determined based on the battery remaining amount of battery packs 2 mounted in the electric vehicle 1. The station indication screen shows an area outside the vehicle movable area in a grayed-out. When a user disables the indication of the vehicle movable area 154 on the e profile setting screen (see FIG. 7(A)), the station indication screen does not indicate the vehicle movable area 154.

The movable distance is a distance that an electric vehicle 1 can travel until the battery packs 2 mounted thereon reaches a user's acceptable battery remaining amount determined from the replacement frequency designated by the user. Therefore, the size of a vehicle movable area differs according to the replacement frequency set by the user. Specifically, in the case of “frequent replacement”, the movable distance is relatively short, and thus the vehicle movable area is smaller, whereas, in the case of “long travel”, the movable distance is relatively long, and thus the vehicle movable area is larger.

The state of a battery station icon 152 indicated on the station indication screen changes depending on whether the battery station is a suitable battery station or not; that is, depending on the result of determination of whether a battery station is one at which battery replacement can be made in such a way that meets a user's needs and to which the user should be led for the battery replacement (suitable battery station determination).

Specifically, for a suitable battery station, the icon 152 is in a valid state and indicated in a color (such as blue) representing the valid state. For a battery station at which battery replacement cannot be made in such a way that meets a user's needs and to which the user should not be led for the battery replacement, the icon 152 is in an invalid state and indicated in a color that indicates the invalid state (such as gray).

In the present embodiment, when the icon 152 of a battery station is in the valid state, in addition to allowing a user to operate the icon 152 for selection, the user can cause detailed information about the battery station to be indicated and cause the screen to transition to the reservation screen (see FIG. 11(A)) for making reservation for battery replacement at the battery station. When the icon 152 is in the invalid state, a user is not allowed to operate the icon 152 for selection.

In the example shown in FIG. 9(A), a user's acceptable wait time is 0 minute, and the user requires two battery packs 2. In this case, the suitable battery station determination is made based on the number of charged battery packs 2 that can be leased at the present moment. Specifically, among the battery stations BS2, BS3, and BS4 in the vehicle movable area, only the battery station BS3 can prepare two available charged battery packs 2 at the present moment, and thus the battery station BS3 is indicated in a color representing the valid state.

In the example shown in FIG. 9(B), a user's acceptable wait time is 5 minutes, and the user requires two battery packs 2. In this case, the suitable battery station determination is made based on the number of charged battery packs 2 that will be available five minutes from the present moment. Specifically, among the battery stations BS2, BS3, and BS4 in the vehicle movable area, the battery stations BS3 and BS4 can prepare two available charged battery packs 2 in five minutes from the present moment, and thus the battery stations BS3 and BS4 are indicated in a color representing the valid state.

In the example shown in FIG. 10(A), a user's acceptable wait time is 10 minutes, and the user requires two battery packs 2. In this case, the suitable battery station determination is made based on the number of charged battery packs 2 that will be available in ten minutes from the present moment. Specifically, all the battery stations BS2, BS3, and BS4 in the vehicle movable area can prepare two available charged battery packs 2 in five minutes from the present moment, and thus the battery stations BS2, BS3, and BS4 are indicated in a color representing the valid state.

In the example shown in FIG. 10(B), a user's acceptable wait time is 0 minute, and the user requires four battery packs 2. In this case, the suitable battery station determination is made based on the number of charged battery packs 2 that can be leased at the present moment. Specifically, among the battery stations BS2, BS3, and BS4 in the vehicle movable area, only the battery station BS5 can prepare four available charged battery packs 2 at the present moment, and thus the battery station BS5 is indicated in a color representing the valid state.

In this way, in the present embodiment, when a user's acceptable wait time is 0 minute, the station indication screen indicates only battery stations that can prepare a required number of available charged battery packs 2 at the present moment. When a user's acceptable wait time is more than 0 minute, even a battery station that does not have any available charged battery pack at the present moment can be a suitable battery station in some cases. When user's acceptable wait time is longer, the number of suitable battery stations can be increased in some cases.

The station indication screen indicates the number of available charged battery packs 2 at each battery station. This number is derived from real-time information about the charge status of battery packs 2 at a battery station. Thus, when the automatic search mode is selected, or when the detailed search mode is selected and a date and time is not designated, the station indication screen as generated using the current date and time as a reference time, indicates the number of available charged battery packs 2 for each battery station.

When a future date and time is designated on the detailed search screen, as it is difficult to predict the number of available charged battery packs 2 at that future date and time, the station indication screen does not indicate the number of available charged battery packs 2. However, as it is possible to acquire an estimated wait time at each battery station at any reference time by analyzing historical information about the past battery replacement status at each battery station, the station indication screen may indicate the estimated wait time.

Next, a reservation screen and a reservation completion screen displayed on a user terminal 5 will be described. FIG. 11 is an explanatory diagram showing the reservation screen and the reservation completion screen.

The reservation screen shown in FIG. 11 (A) is displayed when a user selects a battery station on the station indication screen (see FIGS. 9 and 10); that is, when a user operates (by tapping) a battery station icon 152.

The reservation screen includes a station information section 161, a reservation button 162, and a cancel button 163. The station information section 161 indicates information on a battery station; that is, the name of the battery station and the number of available charged battery packs 2 (the number of remaining batteries).

When a user confirms the information on a battery station and operates the reservation button 162, the management server 4 performs an operation for accepting a reservation for battery replacement. When the reservation operation is completed at the management server 4, the screen on the user terminal 5 transitions to a reservation completion screen (see FIG. 11(B)). When a user operates the cancel button 163, the screen returns to the station indication screen (see FIGS. 9 and 10).

The reservation completion screen shown in FIG. 11(B) includes a reservation completion notification section 171, a battery station information section 172, and a button 173 for return to the start screen. The reservation completion notification section 171 indicates characters for notifying a user of the completion of reservation. The battery station information section 172 indicates battery station information, i.e., the name of a battery station. When a user confirms the completion of reservation and operates the button 173, the screen returns to the start screen (see FIG. 6(B)).

Next, an alert screen displayed on a user terminal 5 will be described. FIG. 12 is an explanatory diagram showing the alert screen.

When a predetermined notification condition is met, the management server 4 provides an alert (notification of the need for battery replacement). In the present embodiment, the alert screen shown in FIG. 12 is displayed on a user terminal 5 as an alert.

The alert screen includes a notification box 181. The notification box 181 is popped up on and overlaid over a standby screen, for example. The notification box 181 indicates characters indicating that a user will soon lose the battery station at which battery replacement can be made in such a way that meets the user's needs, and characters prompting the user to make a reservation for battery replacement.

These contents in the alert screen prevent an electric vehicle from running short of power before reaching a battery station even when the suitable battery station is available for battery replacement.

The management server 4 may be configured to compare the acceptable battery remaining amount for the replacement frequency designated by a user with an actual battery remaining amount of the battery packs 2 mounted in the user's electric vehicle 1, and provide an alert when determining that the actual battery remaining amount is below the acceptable battery remaining amount. In this case, the alert screen may indicate text prompting the user for immediate battery replacement.

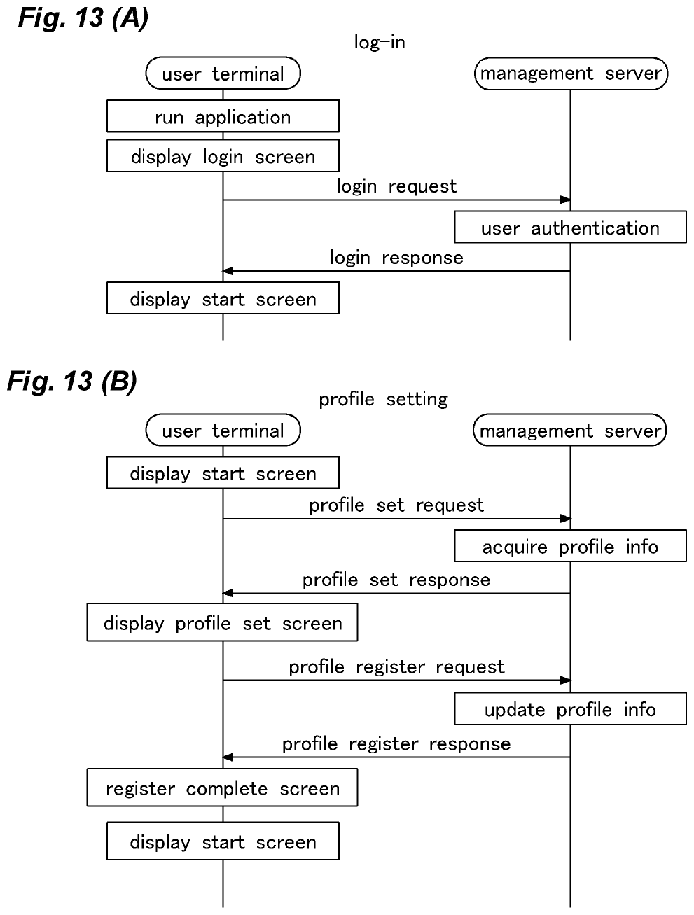

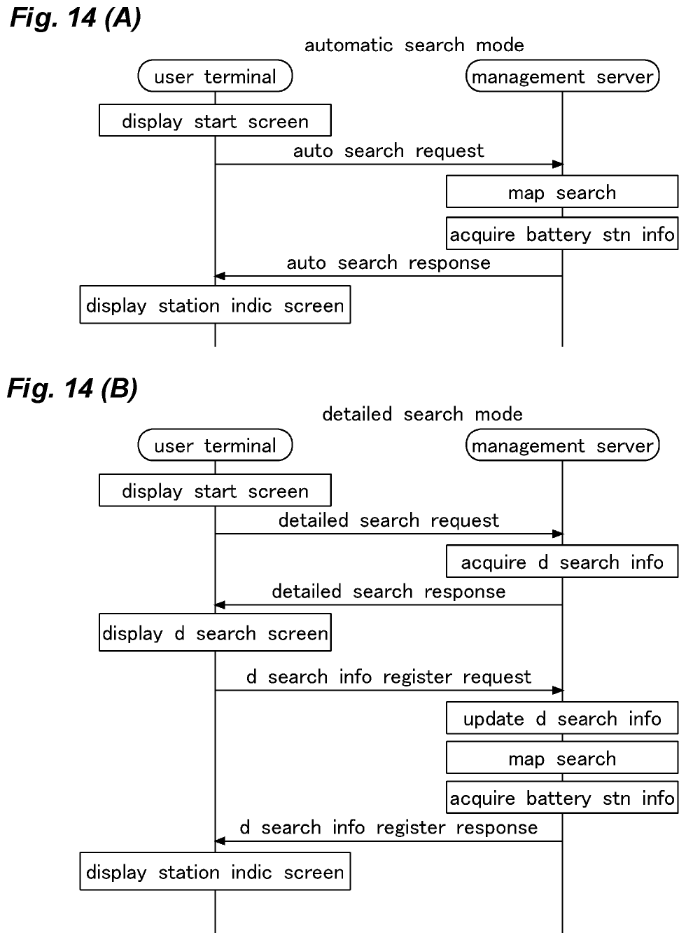

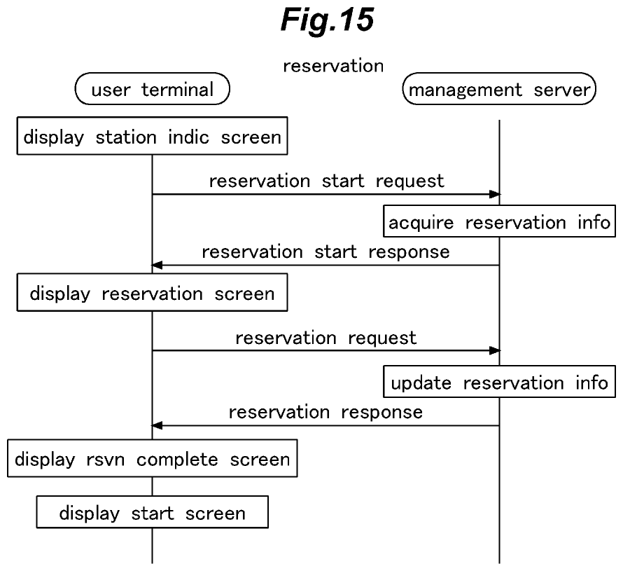

Next, procedures of operations performed by the user terminal 5 and the management server will be described. FIG. 13 is a sequence diagram showing procedures of operations performed by the user terminal 5 and the management server 4 when a user logins and sets a profile, respectively. FIG. 14 is a sequence diagram showing procedures of operations performed by the user terminal 5 and the management server 4 when a user selects an automatic search mode and selects a detailed search mode, respectively. FIG. 15 is a sequence diagram showing procedures of operations performed by the user terminal 5 and the management server 4 when a user makes a reservation.

First, operations associated with login will be explained. As shown in FIG. 13(A), when a battery station navigation application is run, the user terminal 5 first displays a login screen (see FIG. 6(A)). When a user performs a login operation on the login screen, the user terminal 5 transmits a login request to the management server 4.

Upon receiving the login request from the user terminal 5, the management server 4 performs user authentication based on the user ID and a password included in the request, and transmits a login response for indication of a user authentication result to the user terminal 5.

When the user authentication successfully completes; that is, a login is acceptable, upon receiving a login response from the management server 4, the user terminal 5 displays the start screen (see FIG. 6(B)). When the user authentication fails, the user terminal 5 displays an error screen (not shown).

Next, operations associated with profile setting will be described. As shown in FIG. 13(B), when a user operates on the start screen (see FIG. 6(B)) to select profile settings, the user terminal 5 transmits a profile setting request to the management server 4.

Upon receiving the profile setting request from the user terminal 5, when the user has already done profile settings, the management server 4 acquires the profile information on the user's profile settings, and then transmits a profile setting response including profile information on the user to the user terminal 5. In the case of new profile settings, the management server 4 transmits a response that does not contain profile information.

Upon receiving the profile setting response from the management server 4, the user terminal 5 displays a profile setting screen (see FIG. 7(A)) based on the information included in the profile setting response. Next, when a user operates on the profile setting screen to instruct profile registration, the user terminal 5 transmits a profile registration request to the management server 4. The request includes the user's screen operation information (including input information the user has entered on the profile setting screen).

Upon receiving the profile registration request from the user terminal 5, the management server 4 updates the profile information for the user based on the information included in the request. In the case of new profile settings, the management server 4 transmits a profile registration response for indication of a profile registration result to the user terminal 5.

Upon receiving the profile registration response from the management server 4, the user terminal 5 displays the profile registration completion screen (see FIG. 7(B)). Then, when a user performs an operation for return to start, the screen returns to the start screen (see FIG. 6(B)).

Next, operations when the automatic search mode is selected will be described. As shown in FIG. 14(A), when a user selects the automatic search mode on the start screen (see FIG. 6(B)), the user terminal 5 transmits an automatic search request to the management server 4.

Upon receiving the automatic search request from the user terminal 5, the management server 4 sets a target area using the current position of an electric vehicle 1 as a reference position (map search). Next, the management server 4 acquires position information on positions of battery stations located within the target area, and information about the current charge status of battery packs 2 at each battery station (battery station information acquisition). Then, the management server 4 transmits an automatic search response to the user terminal 5. The response includes a map of the target area and information on battery stations located within the target area.

Upon receiving the automatic search response from the management server 4, the user terminal 5 displays a station indication screen (see FIGS. 9 and 10) based on the information contained in the response.

Next, operations when the detailed search mode is selected will be described. As shown in FIG. 14(B), when a user selects the detailed search mode on the start screen (see FIG. 6(B)), the user terminal 5 transmits a detailed search request to the management server 4.

Upon receiving the detailed search request from the user terminal 5, when the user has already selected the detailed search mode, the management server 4 acquires the detailed search information for the user, and then transmits a detailed search response to the user terminal 5. The detailed search response includes information on detailed search mode for the user.

Upon receiving the detailed search response from the management server 4, the user terminal 5 displays a detailed search screen (see FIG. 8) based on the information included in the detailed search response. Next, when a user operates on the detailed search screen to enter search conditions (date and time of use, location of use), the user terminal 5 transmits a search information registration request to the management server 4. The request includes the user's screen operation information (including input information the user has entered on the detailed search screen).

Upon receiving the search information registration request from the user terminal 5, the management server 4 updates the detailed search information for the user based on the information included in the request. The management server 4 sets a target area using the location designated by the user as a reference position, and searches the map of the target area (map search). The management server 4 further acquires information on battery stations (such as position data) located within the target area (battery station information acquisition). Then, the user terminal 5 transmits a search information registration response for indication of a registration result to the management server 4. The response includes the information on battery stations (such as position data) located within the target area (battery station information acquisition). Upon receiving the search information registration response from the management server 4, the user terminal 5 displays the station indication screen (see FIGS. 9 and 10) based on the indication included in the response.

Next, operations for reservation of a battery station will be described. As shown in FIG. 15, when a user selects a battery station on the station indication screen (see FIGS. 9 and 10), the user terminal 5 transmits a reservation start request to the management server 4. The request includes information on the battery station selected by the user.

Upon receiving the reservation start request from the user terminal 5, the management server 4 acquires reservation information on the battery station selected by the user (information on reservation for battery replacement). Then, the management server 4 transmits a reservation start response to the user terminal 5. The response includes the reservation information on the designated battery station; that is, the name of the battery station and the number of available charged batteries (the number of remaining batteries) at the battery station.

Upon receiving the reservation start response from the management server 4, the user terminal 5 displays the reservation screen (see FIG. 11(A)) based on the information contained in the response. When a user operates the reservation screen to make a reservation, the user terminal 5 transmits a reservation request to the management server 4.

Upon receiving the reservation request from the user terminal 5, the management server 4 updates (i.e., sets) reservation information for the selected battery terminal, and then transmits a reservation completion response to the user terminal 5. Concurrently with updating (or setting) reservation information, the management server 4 can update a list indicating the order of lease of battery packs 2 and transmit the updated list to the battery replacement machine, thereby controlling the order of lease of battery packs 2 to the user.

Upon receiving the reservation completion response from the management server 4, the user terminal 5 displays the reservation completion screen (see FIG. 11(B)). Then, when a user performs an operation for return to start, the screen returns to the start screen (see FIG. 6(B)).

In this way, in the present embodiment, upon occurrence of a specific event associated with battery replacement (i.e. occurrence of an event of providing a user with information that leads the user to a suitable battery station for battery replacement or an alert of the need for battery replacement), the management server 4 generates a notification screen for notification of the specific event (i.e., a notification indication screen or an alert screen) based on setting information (profile information) on the user's needs regarding battery replacement and a sold-out index (unavailability index), and then causes the user terminal 5 to display the generated notification indication screen or the alert screen.

In this configuration, a user is provided with battery replacement services including providing information that leads the user to a suitable battery station and providing an alert of the need for battery replacement in such a way that meets the user's needs (that is preferable or desirable to the user), and thus the user can use the services more comfortably. Moreover, a notification screen for notification of a specific event is generated and displayed in a more appropriate manner since the notification screen is generated by using an unavailability index representing a degree of unavailability of battery lease at each battery station.

While specific embodiments of the present disclosure are described herein for illustrative purposes, the present disclosure is not limited to the specific embodiments. It will be understood that various changes, substitutions, additions, and omissions may be made for elements of the embodiments without departing from the scope of the invention. In addition, elements and features of the different embodiments may be combined with each other as appropriate to yield an embodiment which is within the scope of the present disclosure.

### INDUSTRIAL APPLICABILITY

A battery management system and a battery management method for managing battery stations and battery devices, and a terminal device carried by a user used in battery replacement services according to the present disclosure, can provide a user with battery replacement services including providing information that leads the user to a suitable battery station and providing an alert of the need for battery replacement in such a way that is preferable or desirable to the user, and thus the user can use the services more comfortably, and are useful as a battery management system and a battery management method for managing battery stations and battery devices, and a terminal device carried by a user, used in the battery replacement services in which users of electric vehicles and other vehicles can replace battery devices at battery stations.

### Glossary

1 electric vehicle
2 battery pack (battery device)
3 battery replacement machine (battery replacement device)
4 management server (server device)
5 user terminal (terminal device)
51 user manager
54 station information presenter
56 notification manager
58 history analyzer
59 suitable station determiner

1. A battery management system comprising:
a plurality of battery replacement devices placed at a battery station configured to accommodate a battery device returned by a user to charge the returned battery device, and lease a charged battery device to the user in exchange for the returned battery device;
a server device connected to the plurality of battery replacement devices via a network and configured to manage battery replacement statuses of the battery replacement devices; and
a terminal device carried by the user and connected to the server device via the network,
wherein the server device is configured to:
for each battery station, analyze historical information on past battery replacement statuses to generate an unavailability index representing a degree of unavailability of battery lease, and
when a specific event associated with battery replacement occurs, generate a notification screen for notification of the specific event based on setting information on the user's needs regarding battery replacement and the unavailability index, and cause the terminal device to display the notification screen.

2. The battery management system as claimed in claim 1, wherein the server device acquires an amount of time during which battery lease is unavailable within a unit of time, as the unavailability index for each battery station.

3. The battery management system as claimed in claim 1, wherein when the specific event occurs in which the server device provides a user with information that leads the user to a battery station, the server device determines a battery station at which battery replacement can be made in such a way that meets the user's needs, and generates the notification screen in which positions of the determined battery stations are overlaid on a map, and causes the terminal device to display the notification screen.

4. The battery management system as claimed in claim 3, wherein the server device acquires information about a reservation for battery replacement, in response to the user's operation on the notification screen displayed on the terminal device.

5. The battery management system as claimed in claim 1, wherein the server device acquires and stores the setting information in response to the user's operation on the terminal device, the setting information relating to at least one of information records of a replacement frequency, a wait time, alert use settings, and display settings of the notification screen.

6. A battery management method for managing battery stations where a user can replace battery devices and managing the battery devices, wherein the method is performed by a server device, the method comprising:
for each battery station, analyzing historical information on past battery replacement statuses to generate an unavailability index representing a degree of unavailability of battery lease, and
when a specific event associated with battery replacement occurs, generating a notification screen for notification of the specific event based on setting information on the user's needs regarding battery replacement and the unavailability index, and causing a terminal device to display the notification screen.

7. A terminal device carried by a user and connected to a server device via a network, configured to:
display a setting screen that allows the user to enter information on the user's needs regarding battery replacement;
in response to the user's operation on the setting screen, provide setting information on the user's needs regarding battery replacement to the server device; and
when a specific event associated with battery replacement occurs in the server device, display a notification screen for notification of the specific event,
wherein the server device generates an unavailability index representing a degree of unavailability of battery lease for each battery station by analyzing historical information on past battery replacement statuses, and generates the notification screen based on the setting information on the user's needs regarding battery replacement and the unavailability index.
